(19) United States
(12) Patent Application Publication
(10) Pub. No.: US 2019/0303809 A1
(43) Pub. Date: Oct. 3, 2019

(54) PASSENGER AND VEHICLE-FOR-HIRE TRIP INFORMATION SHARING SYSTEM

(71) Applicant: Creative Mobile Technologies, LLC, Long Island City, NY (US)

(72) Inventor: Natasa Karambatsos, New York, NY (US)

(21) Appl. No.: 16/367,219

(22) Filed: Mar. 27, 2019

Related U.S. Application Data
(60) Provisional application No. 62/648,911, filed on Mar. 27, 2018.

(51) Int. Cl. G06Q 10/02; G06Q 50/30; G06Q 30/02; G07C 5/00; H04W 4/40

(52) U.S. Cl. CPC G06Q 10/025; G06Q 50/30; H04W 4/40; G07C 5/008; G06Q 30/0284

(57) ABSTRACT

An information sharing system for sharing information between a passenger and a vehicle-for-hire, preferably for the purpose of providing the owner of the fleet-vehicle with third-party reimbursement of fees.

### FIELD OF THE INVENTION

The present invention relates generally to sharing information between a passenger and a vehicle-for-hire. In particular, the invention relates to an information sharing system for sharing information between a passenger and a vehicle-for-hire, preferably for the purpose of providing the owner of the fleet-vehicle with third-party reimbursement of fees.

### BACKGROUND

Limitations and disadvantages of conventional approaches of passenger and vehicle-for-hire trip information sharing will become apparent to one of skill in the art, through comparison of such approaches with some aspects of the present method and system set forth in the remainder of this disclosure with reference to the drawings.

### BRIEF SUMMARY

Methods and systems are provided for a passenger and vehicle-for-hire trip information sharing system, substantially as illustrated by and/or described in connection with at least one of the figures, as set forth more completely in the claims.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a block schematic diagram of an exemplary computing system, in accordance with one embodiment of the present invention.

FIG. 2 depicts an illustration of a mobile device interacting with and communicating with in-vehicle equipment within a vehicle, in accordance with one embodiment of the present invention.

FIG. 3 depicts a system level illustration of interactions between a passenger, a mobile device, and in-vehicle equipment, in accordance with one embodiment of the present invention.

FIG. 4 depicts an illustration of a commercial ground vehicle-to-passenger linking and trip information management system, in accordance with one embodiment of the present invention.

FIGS. 5 and 6 depict illustrations of interactions between a passenger, a third party, a driver of a vehicle, a trip, and the payment of the trip for a passenger and vehicle-for-hire trip information sharing system, in accordance with one embodiment of the present invention.

FIGS. 7A and 7B depict illustrations of interactions between a passenger, a third party, a trip, and the payment of the trip for a passenger in a vehicle-for-hire trip information sharing system, in accordance with one embodiment of the present invention.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code, and may comprise a second “circuit” when executing a second one or more lines of code. As utilized herein, “and/or” means any one or more of the items in the list joined by “and/or.” As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

In the description that follows, the subject matter of the application will be described with reference to acts and symbolic representations of operations that are performed by one or more computers and/or electronic communications devices, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

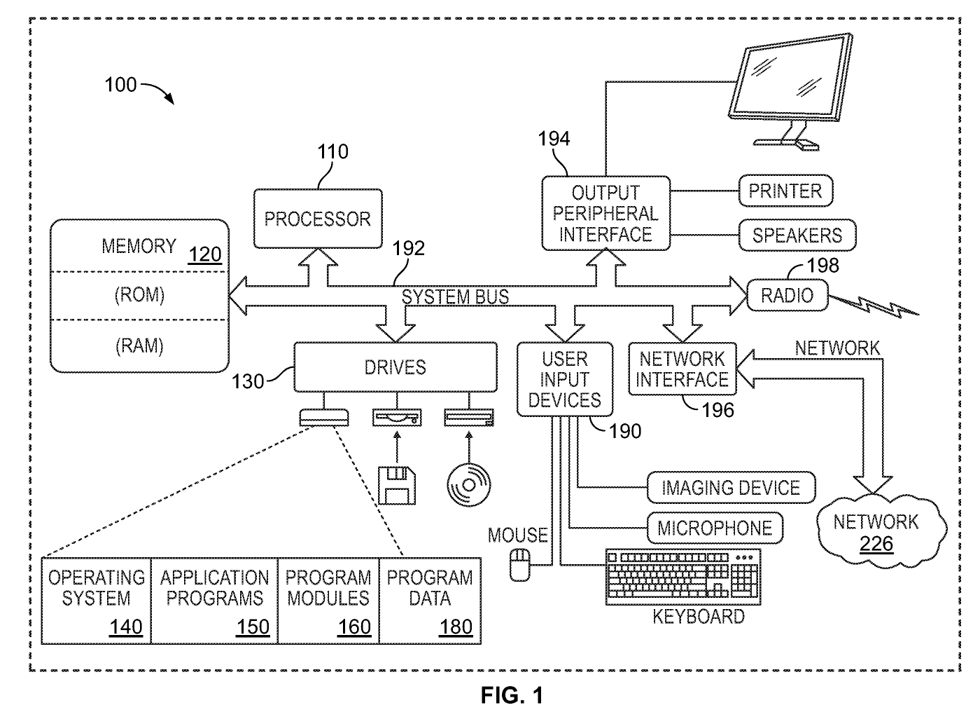

With reference to FIG. 1, depicted is an exemplary system for implementing embodiments of the present invention. FIG. 1 includes an electronic device or computer 100, which could be any one of a local device, such as an electronic communications device 200, or a remote device, such as a remote server 240. Computer 100 may be a mobile electronic communications device 200, wherein at least some or all of its components are formed together in a single device which can be carried around by a person or a local device which is locally accessible by a user, such as an automobile touchscreen computer or a local kiosk, and which may or may not be carried around by a person. The computer 100 includes a processor 110, memory 120 and one or more storage devices 130. The storage devices 130 and their associated computer readable memory medium provide storage of computer readable instructions, data structures, program modules and other data for the computer 100. Storage devices 130 can include an operating system 140, application programs 150, program modules 160, and program data 180. Computer 100 further includes input devices 190 through which data may enter the computer 100, either automatically or by a user who enters commands and data. Input devices 190 can include an electronic digitizer, an image scanner, a barcode reader, a microphone, a camera, a video camera, a keyboard and a pointing device, commonly referred to as a mouse, a touchscreen, a trackball or a touch pad, a pinpad, any USB device, any Bluetooth enabled device, an RFID or NFC device, and a debit card reader. Other input devices 190 may include a joystick, game pad, satellite dish, scanner, and the like. In one or more embodiments, input devices 190 are portable devices that can direct display or instantiation of applications running on processor 110.

These and other input devices 190 can be connected to processor 110 through a user input interface that is coupled to a system bus 192, but may also be connected by other interface and bus structures, such as a parallel port, game port or a universal serial bus (USB). Computers such as computer 100 may also include other peripheral output devices such as speakers, printers, and/or display devices, which may be connected through an output peripheral interface 194 and the like.

Preferably, computer 100 also includes a radio 198 or other type of communications device for transmitting and receiving data for the computer 100, such as wirelessly with the aid of an antenna or wired via use of a network cable. Radio 198 may wirelessly transmit and receive data using protocols such as, for example, WiMAX™, 802.11a/b/g/n/ac, Bluetooth™, 2G, 2.5G, 3G, 4G, and 5G wireless standards.

Computer 100 may operate in a networked environment using logical connections to one or more remote computers, such as a remote server 240. The remote server 240 may be a personal computer, a server, a router, a network PC, a peer device or other common network node, and may include many if not all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN, such as radio 198, to environments such as the Internet. It will be appreciated that other means of establishing a communications link between computer 100 and other computers may be used.

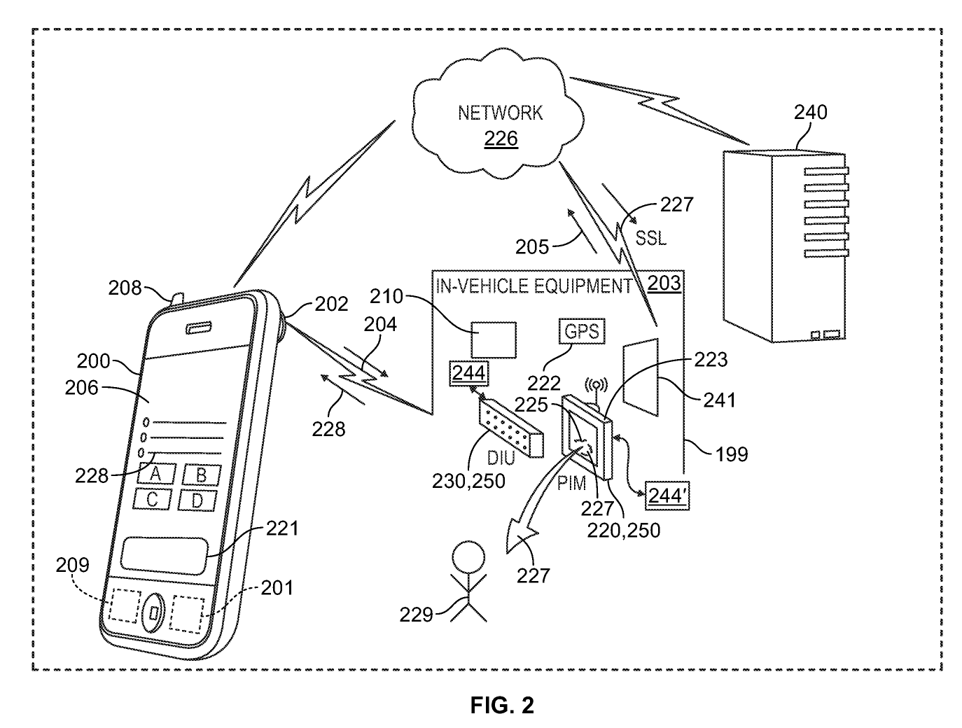

With reference to FIG. 2, illustrated is an exemplary representation of local or mobile electronic communications device 200 for interacting with in-vehicle equipment 203. Electronic communications device 200 includes any local or portable electronic device having a processor 201 for executing applications, a display 206 for displaying information connected with the processor 201, and includes such devices as a personal desktop assistant (PDA), a portable computer, a mobile telephone, a smartphone, a netbook, a mobile vehicular computer, or a tablet computer. Display 206 can use any of a variety of types of display technologies, such as a liquid crystal display (LCD), a cathode-ray tube type display, an electronic ink display, a light emitting diode (LED) type display such as an OLED display, and a plasma display. In one embodiment, the display 206 is able to behave as an input device 190 as well, and includes a touchscreen element, such as a capacitive touchscreen. Preferably, the mobile device 200 also includes a communications device 208. The communications device 208 is connected with the processor 201 and capable of sending and receiving information between one or more other computers connected with the mobile device 200. Preferably the mobile device 200 is a device owned and operated by the passenger 229.

Preferably, communications device 208 and in-vehicle equipment 203 are both capable of wirelessly transmitting signals to another computer, such as remote server 240, using a radio transmitter and a radio receiver connected with an antenna. In one embodiment, a pairing module 202 is capable of sending and receiving passenger information 204 between the mobile device 200 and the in-vehicle equipment 203 in a format that the processor 201 can read, such as digital data. Preferably, pairing module 202 includes any device or combination of devices which can send and/or receive information such as: a near-field communication (NFC) sensor; a wireless transceiver using any one of a number of wireless protocols, such as Bluetooth, wireless a/b/g/n/ac, 2G, 3G, 4G, and LTE; a digital camera; a speaker; and any other type of digital or analog communications device. In another embodiment, passenger information 204 on the mobile device 200 is manually transmitted and input by the user of the device 200, or passenger, into the in-vehicle equipment 203, preferably via a passenger information monitor (PIM) 220, as described below.

In one embodiment, the in-vehicle equipment 203 includes an electronic communications device 200 used by the driver 235 having a display 206, an input device 190, a radio 198, and a processor 201, such as a mobile electronic communications device 200 running an application or app from which the driver 233 receives and inputs information related to the trip 235. In one embodiment, the in-vehicle equipment 203 includes a first electronic communications device used by the driver 235 and a second electronic communications device used by the passenger 229. Preferably, each of the first and second electronic communications devices have a display 206, an input device 190, a radio 198, and a processor 201, such as a mobile electronic communications device 200, and each is capable of running an application, or app, from which the driver 233 or the passenger 229 receives and inputs information related to the trip 235, such as information 204, 205, 227, and 228.

In one embodiment, in-vehicle equipment 203 includes a variety of electronic devices which is located within a vehicle 199, such as a meter 210, a passenger information monitor (PIM) 220, a driver interactive unit (DIU) 230, and a wireless communication device 241. The PIM 220 is preferably coupled to the remote server 240 via a network 226, preferably using a wireless communication device 241, and presents content 227 to the passenger 229 such as for example fleet logos; driver identification; map information; account information; informative information such as news and weather; multimedia content such as advertising, movies, or shows; interactive content such as games or surveys; and may prompt the passenger 229 to enter content, such as passenger trip code information. The PIM 220 presents content 227 to the passenger 229, such as by playing multimedia content or presenting interactive content to the passenger 229, in any number of ways using any number of devices which can be sensed by the passenger 229, such as speakers which emit sound, lighting elements and/or displays which transmit light and/or display images, and/or vibrational elements which may transmit vibrations. PIM 220 may present information to the passenger 229 using a speaker 223 which emits sound and/or a display 225 which displays images. The PIM 220 may also receive content from the passenger 229 such as passenger trip code information, or general information about the passenger 229, information regarding a trip 235 that the passenger wishes to take, such as destination information, or even requests from the passenger 229 to receive information.

Preferably, content 227 is transmitted to the passenger 229 from a remote server 240 through wireless communication device 241 and stored in any storage device 130 or computer 250 located within the vehicle 199, such as PIM 220 or DIU 230. Computer 250 is any computer located within the vehicle 199 which is in communication with wireless communication device 241 and which access to a storage device 130 for storing content 227. Computer 250 may include any computer located within the vehicle having access to a storage device 130, such as PIM 220 and DIU 230. In one embodiment, content 227 is filtered in advance before being transmitted to the computer 250 based on the passenger information 204 and/or vehicle information 205. Optionally, content 227 is filtered based on the passenger information 204 and/or vehicle information 205 upon being transmitted to the computer 250 but before being presented to the passenger 229. Optionally, meter 210 is connected to PIM 220 so as to present fare and toll information via PIM 220 to the passenger 229.

Preferably, communications device 208 is capable of communicating with computer 250 and/or remote server 240, either directly or via a network 226 using a network interface 209. Network interface 209 is connected with processor 201 and communications device 208, and preferably disposed within remote device 200.

Network 226 may include any type of network that is capable of sending and receiving communication signals, including signals for multimedia content, images, data and streaming video. Network 226 may include a data network, such as the Internet, an intranet, a local area network (LAN), a wide area network (WAN), a cable network, and other like systems that are capable of transmitting information, such as digital data, and the like.

Network 226 may also include a telecommunications network, such as a local telephone network, long distance telephone network, cellular telephone network, satellite communications network, cable television network and other like communications systems that interact with computer systems to enable transmission of information between mobile device 200 and another computer such as remote server 240. Network 226 may include more than one network and may include a plurality of different types of networks. Thus, network 226 may include a plurality of data networks, a plurality of telecommunications networks, cable systems, satellite systems and/or a combination of data and telecommunications networks and other like communication systems.

Preferably, network 226 is connected with mobile device 200, in-vehicle equipment 203 such as computer 250, and remote server 240 to allow for information to be transmitted and shared between mobile device 200, computer 250, and remote server 240. Additionally, information may be directly exchanged between the mobile device 200 and in-vehicle equipment 203 via pairing module 202. Information may also be manually shared and exchanged between the mobile device 200 and in-vehicle equipment 203 via a passenger manually entering the information into the in-vehicle equipment 203. Remote server 240 includes any type of computer which can receive, store, process, and transmit information to another computer and includes devices such as a server-based computer system capable of interacting with one or more other computer systems.

In one embodiment, in-vehicle equipment 203 generates location information using location information processing means which allows the in-vehicle equipment 203 to determine the location of the vehicle 199. Location information processing means includes a location-based sensor 222 such a Global Positioning System (GPS) based device, and methods such as using radio triangulation to determine the location of the vehicle 199 and generate location information, which details the geographical location of an item or person. Preferably, mobile device 200 includes input means 211 for entering information from the passenger 229 into the mobile device 200. Input means includes any device which can assist a user to enter information, such as a keyboard, a mouse, a touchpad, a touchscreen, a joystick, a button, and a dial.

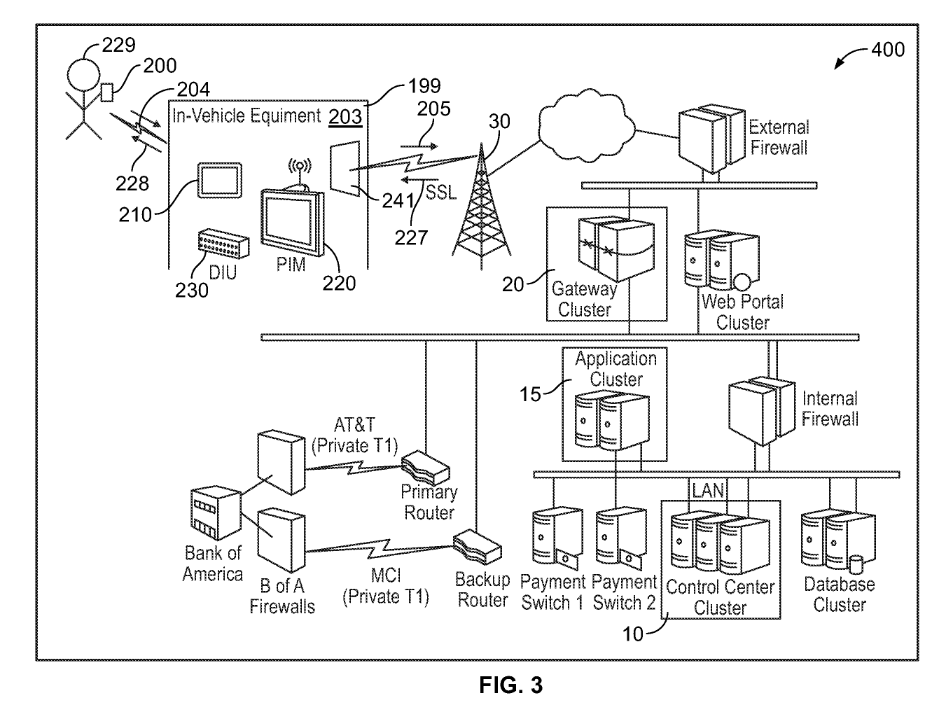

Referring now to FIGS. 3, 4, and 5, an overall environment in conjunction with which the preferred embodiments of commercial ground vehicle-to-passenger linking and trip information sharing system 400 may be practiced is shown. The system 400 obtains and communicates a plurality of types of information 204, 205, 227, and 228 between passengers 229 and vehicles 199. In one embodiment, the system 400 obtains and communicates passenger information 204 which is related to or associated with the passenger 229 and may be obtained from the passenger 229 or derived from the environment around the passenger 229 with the vehicle 199, and specifically in-vehicle equipment 203. The system 400 obtains and communicates vehicle information 205 which is obtained from in-vehicle equipment 203 or the environment around the vehicle 199 with passenger 229, or specifically with passenger's mobile electronic communications device 200.

Preferably, system 400 includes in-vehicle equipment 203 within vehicle 199 that is in communication with a remote server 240 and a mobile device 208. In on embodiment, the in-vehicle equipment 203, includes at least one input device 244 for receiving and inputting passenger trip code information from passenger 229 of the vehicle 199, a location-based sensor 222 to determine the location of the vehicle 199, and a wireless communications device 241 connected with the input device 244. The input device 244 can be in communication with and a part of either a driver interactive unit (DIU) 230 or a personal information monitor (PIM) 220. In one embodiment, the in-vehicle equipment 203 includes two input devices 244, one in communication with the driver interactive unit (DIU) 230 and one in communication with the personal information monitor (PIM) 220. Preferably, the in-vehicle equipment 203 also comprises associated driver circuitry, processing circuitry, network interface circuitry, and control circuitry associated with its components.

In one embodiment, the location-based sensor 222 and associated driver circuitry are operable to capture the location of the vehicle 199 and transmit vehicle location information including the location of the vehicle 199 periodically to the remote server 240.

In one embodiment, the remote server 240, upon receiving a request from a third party 231 to initiate a reservation for a trip 235 for the passenger 229 from a first location to a second location, designates the vehicle 199 for use in trip 235 and associates a passenger trip code 221 with the trip 235 for the passenger 229 in the vehicle 199. Preferably, the remote server 240 communicates the passenger trip code 221 to the in-vehicle equipment 203. Preferably, the passenger trip code 221 is also communicated to the third party 231 and the passenger 229. The remote server 240 chooses and designates the vehicle 199 for use in the trip 235 based upon a variety of information, such as the vehicle location information, the driver 233 of the vehicle 199 reviews and reputation, the time it will take for the vehicle 199 to arrive at the first location.

The trip 235 is any ride that the passenger 229 may take in the vehicle 199 from an initial location to a desired destination or second location. The passenger trip code 221 is any combination of letters and/or numbers, or symbols, that can be used to associate a specific and unique passenger 229 with a specific and unique trip 235. The passenger trip code 221 may be a one-time use code that expires upon use or after a set period of time, or the code may be associated with the passenger 229 for an extended period of time and may be used more than once. The passenger trip code 221 can be issued on a per-trip basis (ex. one passenger trip code 221 issued to a passenger 229 for one specific trip 235); for a specific number of trips 235 (ex. passenger trip code 221 can be capped at ten trips); for an unlimited number of trips 235 over a set period of time (e.g. lasts the duration of a passenger 229's visit to a city); or passenger trip code 221 can have no limit in time until terminated by a person or entity, such as the driver 233 or owner of the vehicle 199, or third party 231.

The passenger trip code 221 may be associated with a card or room key that the passenger 229 maintains in his possession, or the passenger trip code 221 may be a temporary or changing code that the passenger 229 receives, such as via SMS or email message on the mobile electronic communications device 200. In one embodiment the passenger trip code 229 is communicated to the passenger 229 in a textual format, or in a hyperlink with a temporary URL connecting to a web page or web app that opens to a browser showing a live view of the trip.

System 400 may receive the passenger trip code 221 from the passenger 229 or a third party 231, or the system 400 may generate its own unique passenger trip code 221. Upon receiving, associating, or generating the passenger trip code 221, the system 400 communicates the passenger trip code 221 to the in-vehicle equipment 203. If the system 400 generates the passenger trip code 221, then the system communicates the passenger trip code 221 to the passenger 229 either directly or via the third party 231.

The third party 231 is any person or entity that may provide additional goods or services to the passenger 229. The third party 231 can be a hotel that the passenger 229 is staying at, or a paratransit and non-emergency transportation providers that the passenger 229 is using, or any merchant that provides products or services to the passenger 229. In one embodiment, upon receive a request from the passenger 229 to initiate a trip 235, the third party 231 receives funds from the passenger 229 in advance, to pay for at least a portion of the cost of the trip 235. In one embodiment, the third party 231 uses funds owed by the passenger 229, for goods and/or services purchased from the third party 231 by the passenger 229. From these funds, the third party 231 is able to subsidizes or make a payment 237 for a portion of the cost of the trip 235 which would have been otherwise charged to the passenger 229 from the owner of the vehicle 199. In one embodiment, the third party 231, makes a payment 237 from a payment method of the passenger 229 that is on file with the third party 231, such as a credit card of the passenger 229.

In one embodiment, the third party 231 bills the passenger 229 for at least a portion of a cost of the trip 235. One one embodiment, upon completion of the trip 235, the third party bills 231 the passenger 229 for at least a portion of a cost of the trip 235. Preferably, the third party 231 provides the passenger 229 with a consolidated bill, that includes charges for other goods or services provided to the passenger 229 by the third party, and preferably the cost of the trip 235 is also provided to the passenger 229 on that consolidated bill. In this manner, the third party 231 is able to provide a whole host of services and/or goods to the third party 231, and bill them all together on a consolidated bill to the passenger 229, which provides some convenience to the passenger 229.

Preferably, the request to initiate a trip 235 reservation for the passenger 229 originates from the passenger 229 or the third party 231. In one embodiment, the passenger 299 communicates, preferably via the electronic communications device 200, to the third party 231 the passenger 229's desire to initiate a trip 235 from the first location to a second location. The third party 231 then communicates this information to the remote server 240, which in turn then chooses and designates the vehicle 199 for use in the trip 235 based upon a variety of factors, as discussed above. In one embodiment, the request to initiate a trip 235 reservation for the passenger 229 originates from the passenger 229 and is communicated to the third party 231, preferably via mobile electronic communications device 200. Once the request to initiate a trip 235 reservation is received by the third party 231, the third party then communicates the request to the owner of the vehicle 199, preferably via server 240. Preferably, once the request to initiate a trip 235 reservation is received by the third party 231, the third party 231 requests that the passenger 229 keep the mobile electronic communications device 200 powered ON, requests that that the passenger 229 provide the third party 231 contact information from the passenger 229, such as the telephone number of the mobile electronic communications device 200, and/or confirms that the contact information from the passenger 229 is accurate and/or is the same as is kept on file by the third party 231 for that passenger 229. Contact information from the passenger 229 is any information associated with the passenger 229 that can be used to contact the passenger 229, such as the passenger 229's telephone number, email address, and home address, instant messaging address, and any other means of contacting the passenger 229.

Once the vehicle 199 is designated for use in the trip 235, passenger trip code 221 is then either generated, or looked up, and associated with the trip 235 for the passenger 229 in the vehicle 199 and communicated to the in-vehicle equipment 203. The passenger trip code 221 may also be communicated to the passenger 229, preferably via the mobile electronic communications device 200.

In one embodiment, passenger information 204 includes passenger trip information which is communicated to the in-vehicle equipment 203. Passenger trip information is information that is useful to the passenger 229 regarding the trip and includes things such as: the route and/or identifying information for the route such as the first/starting location of the trip and/or the second/final/ending location of the trip; identifying information for the vehicle 199 such as the make/model/color of the vehicle 199, the license plate of the vehicle 199, and/or the medallion number of the vehicle; identifying information for the driver 233 such as the driver's name, the driver's description, the driver's image or picture, and/or the driver's ID number; and/or a passenger trip code which is a unique alphanumeric code which identifies the trip 235. In one embodiment, passenger trip information includes the passenger trip code 221, the first location, and the second location, and preferably identifying or personal information about the passenger 229 and/or the vehicle 199 or driver 233. In one embodiment, passenger trip information includes the current location of the passenger 229. Passenger trip information may include information provided by the passenger 229 and the driver 233. Upon receipt of the passenger trip information, the driver 233 of the vehicle 199 is then instructed to proceed to the first location as soon as possible to start the trip 235 and pick-up the passenger 229.

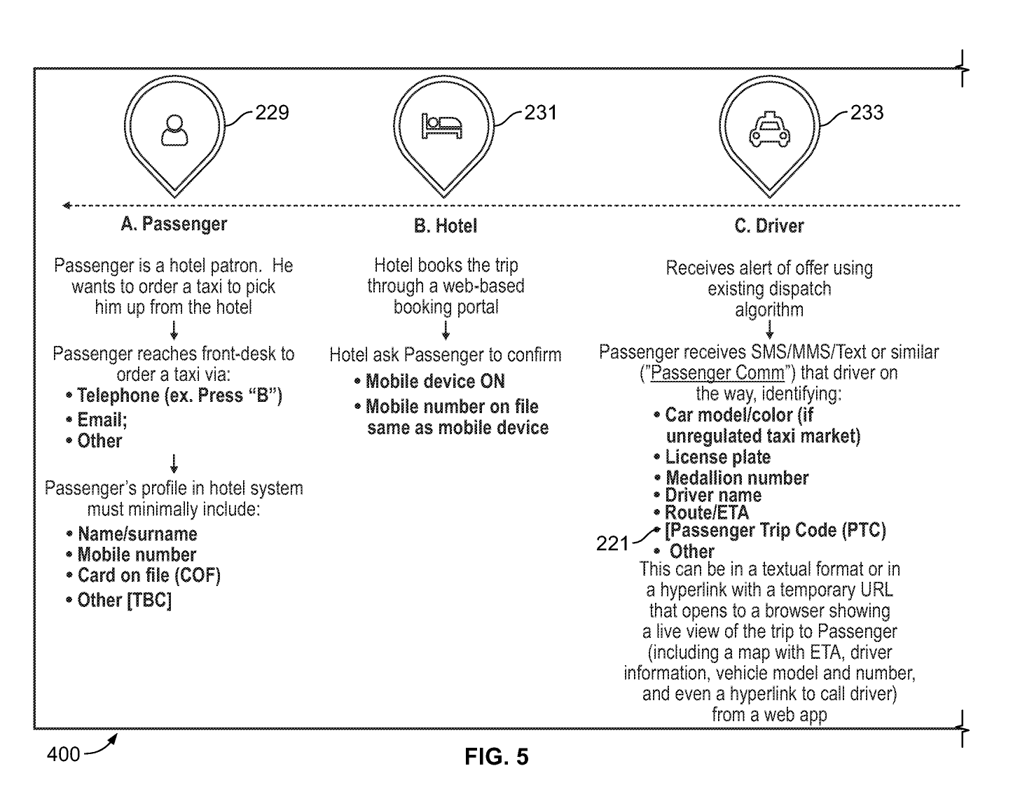

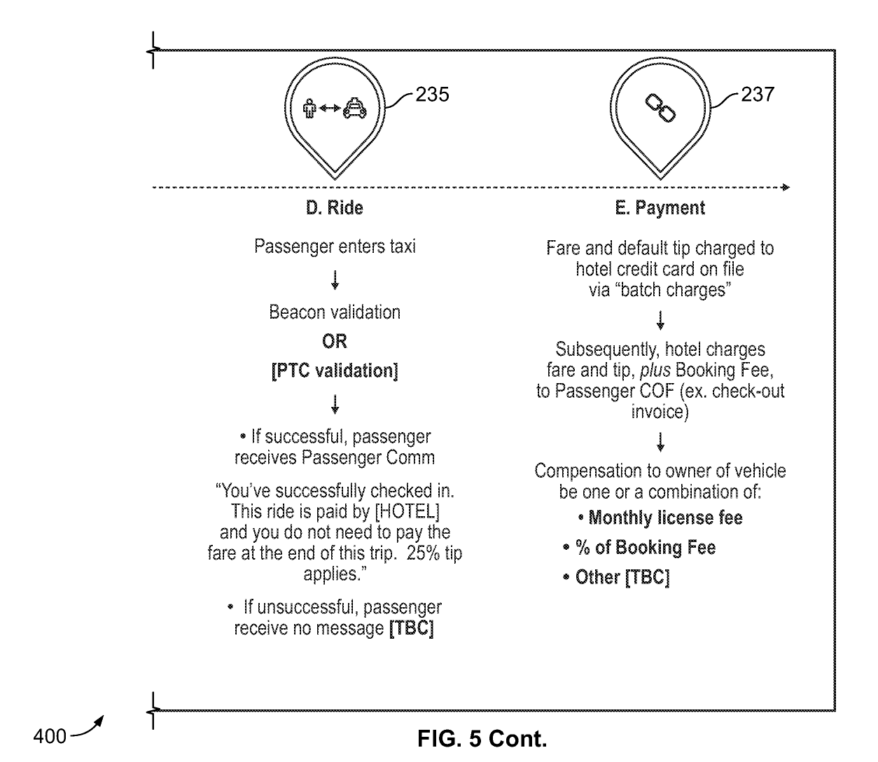

As shown in FIG. 5, in one embodiment, passenger trip information, including the passenger trip code 221, is communicated to the passenger 229, who uses the passenger trip information to proceed to the first location to find and then enter the vehicle 199. In one embodiment, the passenger trip code 221 is communicated to the passenger by the third party 231. Preferably, the third party 231 communicates the passenger trip code 221 directly to the mobile electronic communications device 200 of the passenger 229, preferably, via one of an SMS message, an email, via the internet, or via information that is downloaded from a remote server via an app or application running on the mobile electronic communications device 200. With this passenger trip code 221, the passenger 229 is able to initiate the trip 235.

In one embodiment, the passenger trip code 221 is then used to associate the trip 235 and the cost of the trip 235 with the passenger 229, so that the third party 231 is able to later bill the passenger 229 for the trip. In one embodiment, upon associating the passenger trip code 221 with the trip 235 and the cost of the trip 235, the third party 231 pays for at least a portion of the cost or all of the cost of the trip 235. Preferably, upon paying for at least a portion of the cost or all of the cost of the trip 235, the third party 231 then later bills the passenger 229 for at least a portion of the cost or all of the cost of the trip 235.

Upon entering the vehicle, the passenger 229 then communicates passenger trip code information to either the driver 233 of the vehicle 199, who proceeds to enter the passenger trip code information into the DIU 230 or the mobile electronic communications device 200 of the driver 233, or the passenger 229 enters the passenger trip code information into the PIM passenger information monitor (PIM) 220 or the mobile electronic communications device 200 of the passenger 229. The passenger trip code information is information communicated from the passenger 229 to the driver 233 or the in-vehicle equipment 203 representative of the passenger trip code 221.

Upon receiving the passenger trip code information from the passenger 229 or driver 233, the in-vehicle equipment 203 then communicates the passenger trip code information to the remote server 240 via the wireless communications device 241. Preferably, the control circuitry of the in-vehicle equipment 203 is operable to detect signals from input device 244 that represent the passenger trip code information and then relay this information to the remote server 240.

Upon receiving the passenger trip code information from the in-vehicle equipment 203, the remote server 240 then compares the passenger trip code information which was initially received from the passenger 229, and communicated to the driver 233 or the in-vehicle equipment 203, with the passenger trip code 221 associated with the trip 235 for the passenger 229 in the vehicle 199, in order to validate the trip 235 reservation. If the passenger trip code information matches the passenger trip code 221, and the passenger trip code 221 is still valid, the trip 235 is validated and the driver 233 and/or vehicle 199 can initiate the trip 235 from the first location to the second location.

Upon completion of the trip 235, the cost of the trip 235 needs to be paid. In one embodiment, the passenger 229 provides the passenger trip code 221 as payment for at least a portion of the cost or all of the cost of the trip 235. The third party 231 then later bills the passenger 229 for at least a portion of the cost or all of the cost of the trip 235. In one embodiment, upon completion of the trip 235, the passenger 229 provides the passenger trip code 221 as payment for at least a portion of the cost or all of the cost of the trip 235, and then the passenger 229 provides payment for a remainder of the cost of the trip 235. Preferably, upon ending the trip 235, the passenger trip code 235 is provided by communicating the passenger trip code information to either the driver 233 of the vehicle 199, who proceeds to enter the passenger trip code information into the DIU 230 or the mobile electronic communications device 200 of the driver 233, or the passenger 229 enters the passenger trip code information into the PIM passenger information monitor (PIM) 220 or the mobile electronic communications device 200 of the passenger 229.

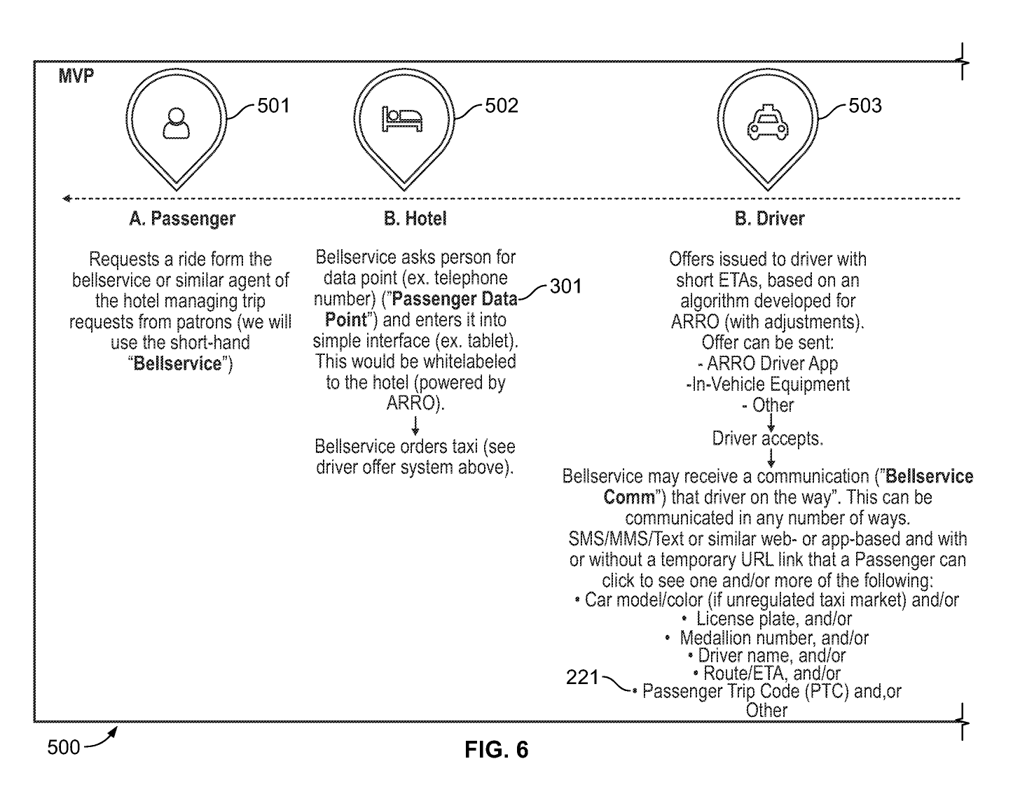

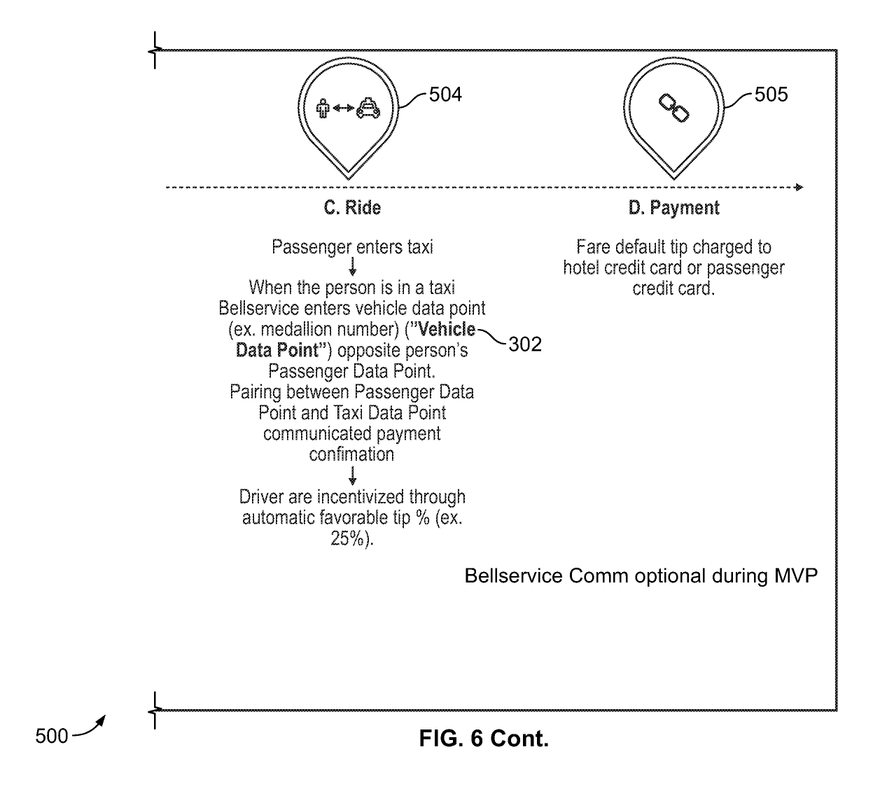

With Reference to FIG. 6, in one embodiment, passenger information 204 includes a passenger data point 301 which is paired with a vehicle data point 302 in order to initiate the trip 235, as described in steps 501-505 via method 500. The passenger data point 301 is any identifying information about the passenger 229, such as a name, a username, an address, a membership ID, social security number or other unique alpha-numerical identifier which uniquely identifies the passenger 229. The vehicle data point 302 is any identifying information about the vehicle 199, such as a medallion number, license plate number, VIN number, vehicle make/model/color, or any other identifying information about the vehicle, such as the vehicle's location. In one embodiment, the vehicle data point 302 can be any information that uniquely identifies the driver 233 of the vehicle 199, such as the name of the driver 233, the driver's license number of the driver 233, a username of the driver 233, an address of the driver 233, a membership ID of the driver 233, a social security number of the driver 233 or any other unique alpha-numerical identifier of the driver 233 which uniquely identifies the driver 233.

At step 501, the passenger 229 requests a ride, or expresses an intent to initiate the trip 235, either directly via an electronic communications device 200 or via a third party 231. The third party 231 is any person or entity that may provide additional goods or services to the passenger 229. The third party 231 can be a hotel that the passenger 229 is staying at, or a paratransit and non-emergency transportation providers that the passenger 229 is using. In one embodiment, the passenger 229 requests a ride from an employee of the third party 231, such as a bellboy of a hotel, who then engages an electronic communications device 200.

At step 502, at a display of the electronic communication device 200, a user, either the passenger 229 or the third party 231, is prompted to enter passenger information 204, preferably a passenger data point 301, identifying the passenger 229 and indicating the passenger 229's request to initiate a trip 235. In one embodiment, the third party 231 then ask for and receives from the passenger 229 passenger information 204, and preferably, a passenger data point 301. Preferably, the passenger information 204/passenger data point 301 is paired with passenger information stored in a database of the third party 231. The passenger information can include the passenger's payment information, along with the passenger's expenses information. Upon receiving the passenger information 204/passenger data point 301, the user then enters the passenger information 204/passenger data point 301 into the electronic communications device 200, which then communicates the passenger information 204/passenger data point 301 to the server 240. In one embodiment, if the user is the third party 231, the passenger information 204/passenger data point 301 is communicated to a database of the third party 231, preferably via a mobile device such as a tablet or mobile smartphone, and then the third party 231 sends a request for a ride, or expresses an intent to initiate the trip 235 for the passenger 229 to the server 240.

At step 503, the passenger 229's request to initiate a trip 235 is communicated to the remote server 240 and then the remote server 240 communicates the passenger 229's request to initiate a trip 235 via an offer to a second electronic communication device 200 of the driver 233 of the vehicle 199, such as the DIU 230. In one embodiment, the third party 231 submits a request for a ride, or expresses an intent to initiate the trip 235, to the remote server 240 associated with the passenger information 204/passenger data point 301 via an electronic communications device 200 of the third party 231. Upon receiving the request, the remote server 240 then generates and issues an offer to preselected drivers 233 and communicates that offer to each preselected driver 233 via a second electronic communication device 200 of the driver 233, such as the driver interactive unit (DIU) 230. The preselected drivers 233 are selected preferably by using an algorithm that determines which drivers 233 from a pool of drivers 233 should be preselected based on a number of criteria, such as distance from the passenger 229, the estimated time of arrival (ETA) to arrive at the passenger 229's location, the driver 233's ranking or average review score, and other such information. Each driver 233 is associated with a vehicle data point 302. Preferably, each driver 233 is prompted at a display of the second electronic communication device 200 to accept or deny the offer to initiate a trip 235 for the passenger 229.

At step 503, upon receiving the offer from the remote server 240, preferably, the first preselected driver 233 to accepts the offer is then paired with the passenger 229. Preferably, the remote server 240 pairs the passenger information 204/passenger data point 301 with the vehicle data point 302 of the first driver 233 who accepts the offer received from the server 240. At step 503, once the remote server 240 pairs the passenger information 204/passenger data point 301 with the vehicle data point 302 of a driver 233 who accepts the offer received from the server 240, the third party 231 or the passenger 229 via the electronic communications device 200 then receives a communication that a driver 233 has accepted the offer and is on the way to retrieve the passenger 229 and initiate the trip 235. Preferably, information for identifying the vehicle 199, such as the vehicle data point 302, is also communicated to the third party 231 or the passenger 229 so that the third party 231 or the passenger 229 may identify the vehicle 199 or the driver 233. The acceptance of the offer may be communicated to the third party 231 or passenger 229 via the electronic communications device 200 in many ways, such as to a server/computer/mobile device of the third party 231 via any number of means of communication, such as SMS, MMS, Text message, HTML or any web-based communication or app, via a temporary URL link, etc. Upon acceptance of the offer, passenger trip information is then communicated to the third party 231, and preferably to the passenger 229 as well. Preferably, the passenger trip information includes information for identifying the vehicle 199 communicated to the third party 231 to helps to identify the vehicle by containing any of the following: the vehicle make/model/color, the vehicle license plate, the medallion number, the driver 233's name, the route, the estimated time of arrival (ETA), the passenger trip code 221, and/or any other information related to the trip such as passenger trip information.

At step 504, upon arrival of the vehicle 199 at the passenger 229's location, the vehicle 199 is identified and the passenger 229 then enters the vehicle 199. In one embodiment, the vehicle 199 is identified by the passenger 229, the third party 231 or an employee of the third party 231 using the passenger trip information communicated to the electronic communications device 200. Upon identifying the vehicle 199, the passenger enters the vehicle 199 and then the vehicle 199 is paired with the passenger 229 by either: 1) the third party 231, or an employee of the third party 231, pairs/associates the vehicle data point 302 with the passenger data point 301, preferably by using electronic communications device 200 and communicating and associating both the vehicle data point 302 with the passenger data point 301 to the remote server 240, preferably via a mobile device; or 2) the passenger 229 enters or communicates passenger trip code information received to a PIM 220 of the vehicle 199 to pair the passenger 229 with the vehicle 199 or trip and then communicating the passenger trip code information to the server 240. Communicating and associating both the vehicle data point 302 with the passenger data point 301 to the server 240 indicates that the passenger 229 has accepted the ride or trip 235 and that payment of the ride or trip 235 will be made in some form. In one embodiment, the fare is communicated to the electronic communications device 200. Upon completion of the trip, the fare is charged, preferably to either the third party 231 or the passenger 229.

At step 505, in one embodiment, preferably the fare and default tip for the trip are charged to and paid by the third party 231 or passenger 229, via a form of payment on record for the passenger 229 such as a credit card. In one embodiment, payment for the trip 235 is initially made by the third party 231. In one embodiment, payment for the trip is directly billed to the passenger 229 and paid by a form of payment on record for the passenger 229. Preferably, if payment for the trip 235 is initially made by the third party 231, the passenger 229 later reimburses the third party 231. In one embodiment, the driver 233 is incentivized to participate in the method 500 through an automatic favorable tip, such as an automatic tip in excess of 20%, or in excess of 25%.

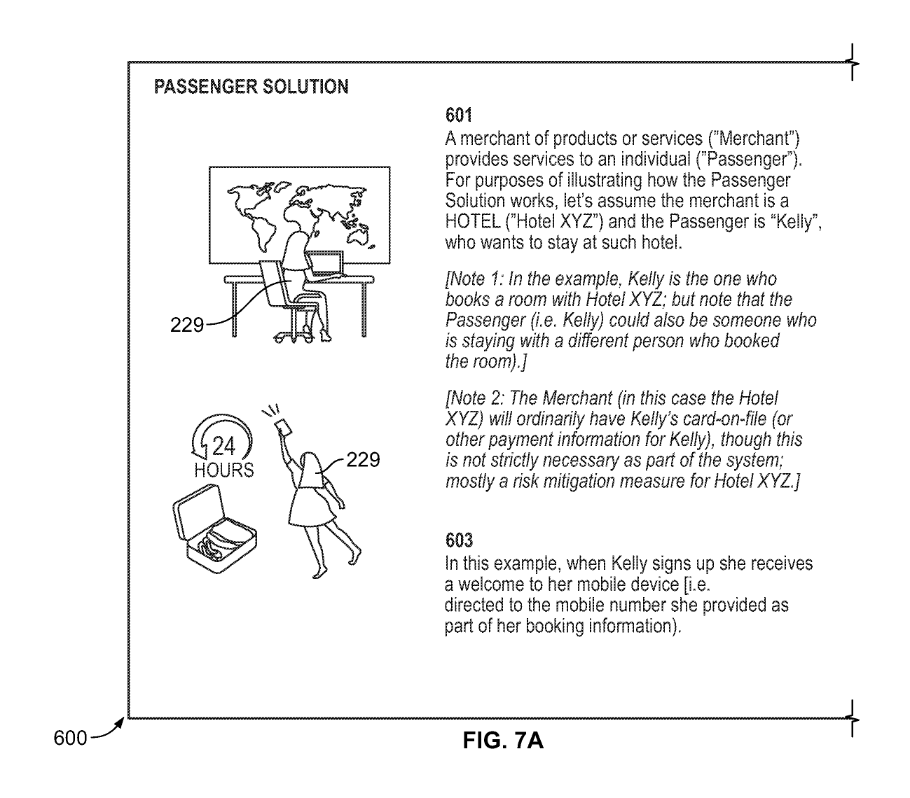

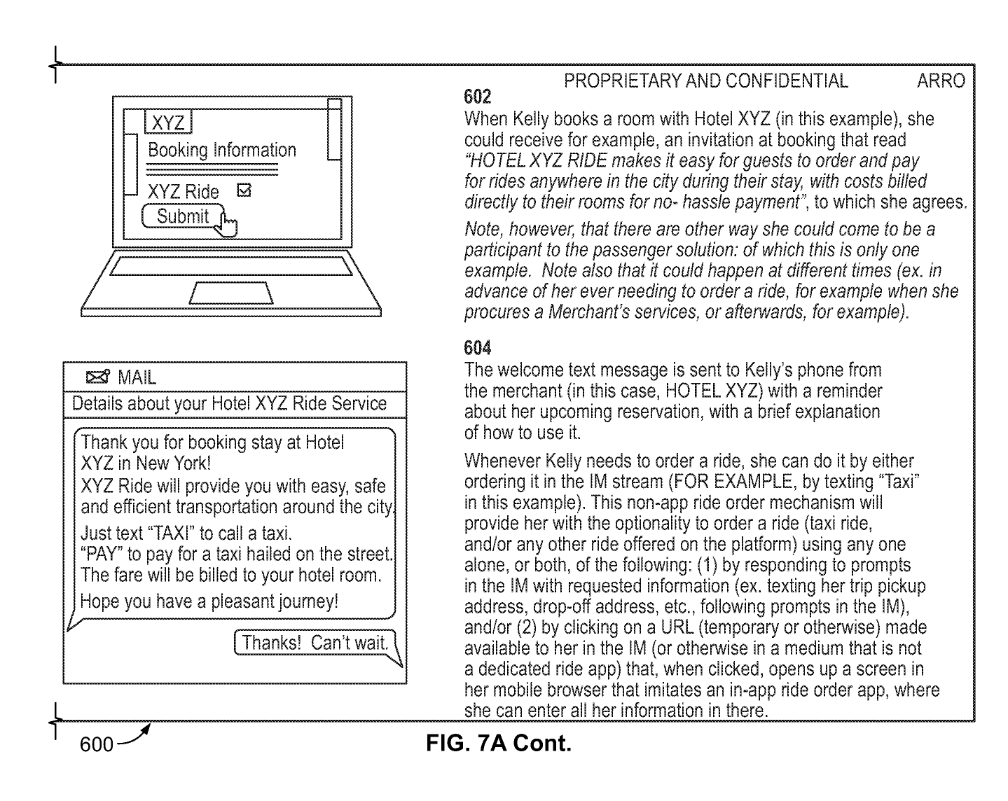

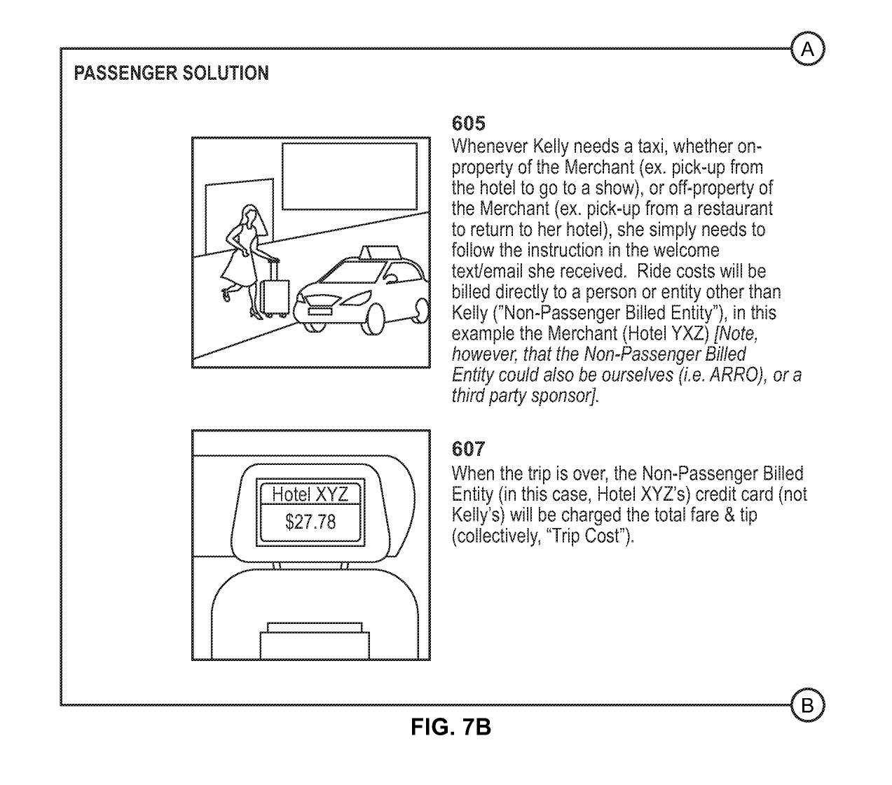

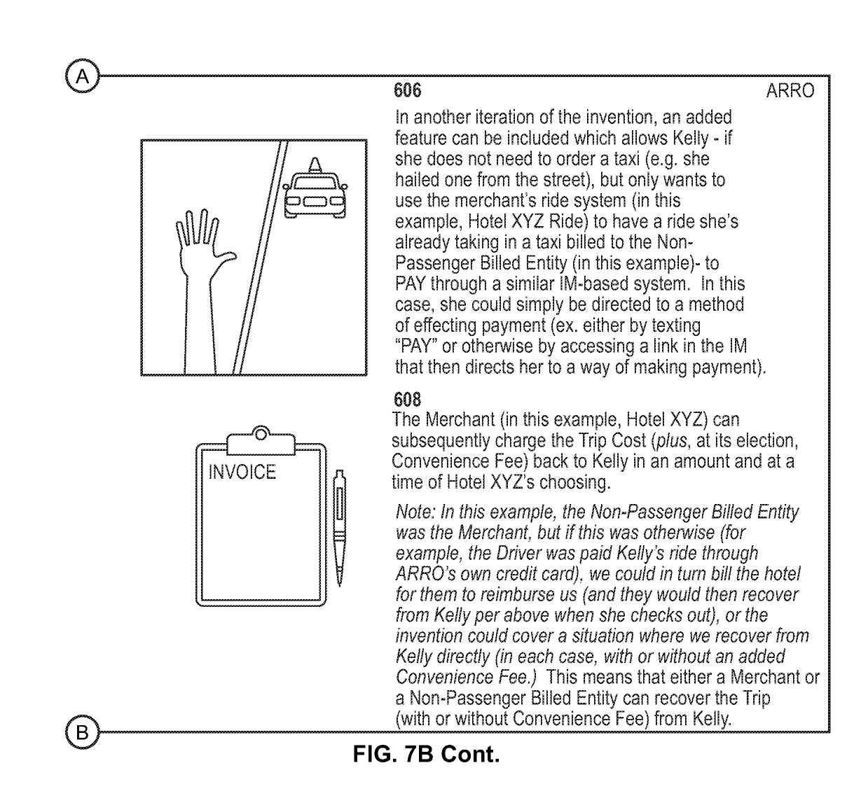

With reference to FIGS. 7a and 7b, in one embodiment, a third party 231, such as a merchant of products or services, provides services to an individual or passenger 229 which include allowing the passenger 229 to initiate the trip 235 on their own and pay for the trip 235, as described in steps 601-608 via method 600. As shown in FIG. 7a, at step 601, a merchant of products or services, also know herein as a third party 231, provides services to an individual or passenger 229. In one embodiment, third party 231 is a hotel and the passenger 229 is a person who wants to stay at such hotel owned by the third party 231. In one embodiment, the passenger 229 purchases or commits to purchase a product or service from the third party 231, such as books a hotel room with the third party 231. In one embodiment, someone associated with the passenger 229 purchases a product or service from the third party 231.

Upon purchasing or committing to purchase a product or service from the third party 231, the passenger 231 or someone associated with the passenger 231 provides the third party 231 with payment information, which is information associated with any form of payment such as a credit card number, for a payment from the passenger 229 for the product or service to be purchased from the third party 231. Next, the passenger 229 provides contact information associated with the passenger 229 to the third party 231, such as the telephone number of the mobile electronic communications device 200, and/or confirms that the contact information from the passenger 229 is accurate and/or is the same as is kept on file by the third party 231 for that passenger 229. In one embodiment, the third party 231 may already have the passenger 229's payment information and/or contact information on-file or in their records, and therefore may not need to ask the passenger again for their contact information or payment information again. In this instance, the third party 231 may ask for the passenger to confirm his contact information or payment information. Contact information from the passenger 229 is any information associated with the passenger 229 that can be used to contact the passenger 229, such as the passenger 229's telephone number, email address, and home address, instant messaging address, and any other means of contacting the passenger 229.

At step 602, once the passenger 229 purchases or commits to purchase a product or service from the third party 231, the passenger 229 is contact using the contact information provided by the passenger 229 to the third party 231 and the passenger 229 then receive a communication from the third party 231, preferably via email or via a text messaging service, which introduces the passenger 229 to a passenger solution/service for ordering and paying for trips 235 to made using vehicles 199 all arranged through the third party 231. Preferably, the trips 235 are billed to the third party 231 for payment, which in turn may then compensate or reimburse the passenger 229 for a certain amount of trips 235 or which may bill the passenger 229 for the trips 235. In this manner, the passenger 229 who is already receiving and paying for products and services from the third party 231, is able to receive additional services, such as trips 235, from the third party 231, which may or may not be billed together with the other products and services already being received. The communication received at step 602 may be one of many ways that the passenger 229 comes to be a participant to the passenger solution offered by the third party 231. Additionally, the communication at step 602 may occur at different times (ex. in advance of the passenger 229 ever needing to order a trip 235, for example when the passenger 229 procures a services or products from the third party 231, or afterwards, for example. By sending the communication to the passenger 229 using the contact information provided by the passenger 229, the third party 231 can be sure that it is communicating with the passenger 229 and can then confidently act upon any instructions received by the passenger 229, such as instructions to initiate a trip 235.

At Step 603, when the passenger 229 signs up for the passenger solution offered by the third party 231, the passenger 229 receives a welcome communication, preferably via a text message to her mobile device 200, and preferably this is sent to a mobile number provided to the third party at the time the passenger 229 provides contact or payment information to the third party 231. Moving to Step 604, the welcome communication, or welcome text message, is sent to the passenger 229's mobile device 200 from the third party 231, preferably with a reminder about her upcoming reservation or upcoming services which have been purchased from the third party 231, along with a brief explanation of how to order a trip 235 from a vehicle 199.

At Step 604, whenever the passenger 229 needs to request a ride, or expresses an intent to initiate the trip 235, the passenger 229 needs to communicate this intention to the third party 231, preferably via the mobile device 200. In one embodiment, the passenger 229 communicates the intent to initiate the trip 235 by ordering the trip 235 via a text message response to the initial text message received by the passenger 229 from the third party 231, such as a response made in the instant message stream between the passenger 229 and the third party 231. In one embodiment, for example, the passenger 229 may text back to the third party 231 a word or a series of words such as “TAXI”, for example, which when received by the third party 231, and preferably by a computer system at the third party 231, indicates the passenger 229's desire to initiate a trip 235. Again, by receiving instructions from a passenger 229 whose contact information is already known and associated by the third party 231 with payment information, such as a credit card of the passenger 229, the third party 231 can confidently act upon any instructions received by the passenger 229, such as instructions to initiate a trip 235.

This mechanism provides the passenger with a method to initiate a ride or trip 235 without having to use a specialized app. Using this method, the passenger 229 is able to initiate a trip 235 by simply using text messages and responding to prompts in the stream of text messages between the passenger 229 and the third party 231 with requested information, such as passenger trip information. For example, the passenger 229 may provide passenger trip information which includes the passenger 229's current location or a first location from where the trip 235 is to start and a second location from where the trip 235 is to end. Such passenger trip information may include the passenger 229's trip pickup address (first location), drop-off address (second location), etc., following prompts in the instant message stream of text messages. Alternatively, at Step 604, the passenger 229 may initiate a trip by selecting or clicking on a URL (temporary or otherwise) made available to the passenger 229 in the instant message (IM) or text message stream between the passenger 229 and the third party 231, or in some other medium that is not a dedicated ride app, such as via email, that, when clicked, opens up a screen in a web browser on her mobile device 200 that helps the passenger initiate a trip 235 by providing and entering information such as passenger trip information. In one embodiment, the URL is a custom URL which is setup specifically for a specific passenger 229 so that all information entered in that custom URL can automatically be associated with a specific passenger 229. By having the passenger 229's contact information, and by sending the custom URL to the passenger using the passenger 229's provided contact information, the third party 231 can be confident in assuming that any instructions received by the passenger 229, such as instructions to initiate a trip 235, are from the passenger 229 whose is associated with the provided contact information and therefore the third party 231 can act upon those instructions and charge the passenger 229 using the payment information provided by and associated with the passenger 229.

At Step 605, whenever the passenger 229 needs to initiate a trip 235, whether on the property of the third party 231 (ex. for a pick-up from a hotel to go to a second location), or off the property of the third party (ex. to pick-up from a second location and return back to the third party 231's property, the hotel), the passenger 229 needs to follow the instructions in the welcome communication (text/email) the passenger 229 received, which may require the passenger 229 to provide the third party 231 with passenger trip information, such as the passenger's current location. Preferably, costs associated with the trip 235 will be billed directly to a person or entity other than the passenger, (“Non-Passenger Billed Entity”), in this example the third party 231. However, the Non-Passenger Billed Entity could also be any entity other than the third party 231, such as an entity that provides trips to passengers 229, such as a taxicab company, or a third party sponsor. Upon requesting that a trip 235 is initiated, the third party 231 communicating the passenger 229's request to initiate a trip via an offer to a second electronic communication device of a driver of a vehicle 199. In one embodiment, this communication to the driver of a vehicle 199 is done through a Non-Passenger Billed Entity. Preferably, such communication then prompts, at a display of the second electronic communication device, the driver to accept or deny the offer to initiate a trip for the passenger 229. Preferably, the passenger 229 is then paired with a vehicle 199 associated with the driver upon acceptance of the offer.

At Step 606, in one embodiment, if the passenger 229 does not need to initiate a trip 235 using the passenger solution offered by the third party 231, (e.g. the passenger 229 already hailed a vehicle or taxi from the street), but rather the passenger wants to use the passenger solution offered by the third party 231 have a ride or trip 235 the passenger 229 is already taking in a vehicle 199 billed to the Non-Passenger Billed Entity, the passenger 229 could simply be directed to a method of effecting payment, for example in the initial welcome communication. For example, the initial welcome communication the passenger 229 could be directed to pay for an existing ride or trip 235 by providing the passenger 229 instructions or a URL (temporary or otherwise) to select that that then directs the passenger to a way of making payment, or by simply texting back to the third party 235 a message such as “PAY” or otherwise which then initiates a sequences between the passenger 229 and the third party 231 which leads to payment for the ride or trip 235, such as providing the passenger 229 with a link or URL to a payment site.

At Step 607, when the ride or trip 235 is over, the Non-Passenger Billed Entity (in this case, the third party 231) account or credit card will be charged the total fare & tip, collectively known as the “Trip Cost”. Then at Step 608, the Non-Passenger Billed Entity, which may also be the third party 231, can then subsequently charge the Trip Cost (plus, at its election, a Convenience Fee) back to the passenger 229 in an amount and at a time of the Non-Passenger Billed Entity's choosing. In method 600 detailed above, the Non-Passenger Billed Entity and the third party 231 were one and the same for most of the example, but they may be different entities as well. For example, the driver of the vehicle 199 could be paid for the trip 235 through a Non-Passenger Billed Entity which is a ride share service or an owner of a fleet of vehicles, which could in turn bill the third party 231, such as a hotel, for them to reimburse the Non-Passenger Billed Entity, and then the third party 231 would recover the fees for the trip 235 from the passenger 229 per above when the passenger gets billed for products and/or services purchased from the third party 231. Alternatively, the Non-Passenger Billed Entity can recover the fees for the trip 235 from the passenger 229 directly (in each case, with or without an added Convenience Fee). This means that either a third party 231 or a Non-Passenger Billed Entity can recover the Trip Cost (with or without Convenience Fee) from the passenger 229. As a result, by using method 600 disclosed in steps 601-608, a passenger 229 can simply order a trip 235 using a third party 231 by simply sending text messages back and forth between the passenger and the third party 231, and not have to pay for the trip 235 until a later time.

In addition to the in-vehicle equipment 203 described herein, the system 400 further includes a central control center 10, a gateway 20, and a wireless service provider 30. The wireless service provider 30 provides a distribution network for communicating information 204, 205, 227, and 228 to and from each of the vehicles 199. The wireless service provider 30, gateway 20 and the central control center 10 are configured to be able to handle a large number of simultaneous communication channels from a plurality of vehicles 199.

In one embodiment, there may also be at least one content provider (not shown in FIG. 3), providing general content to be controllably distributed to the plurality of vehicles 199. Preferably, the primary content 227 is targeted content derived from the general content and based upon the passenger information 204 and/or the vehicle information 205.

Gateway 20 is a messaging gateway that communicates and maintains connections with each vehicle 199. Central control center 10 is the message processing application for all inbound and outbound communication with in-vehicle equipment 203, and preferably, with PIM 220. Preferably, central control center 10 resides on remote server 240 and guarantees delivery of all messages to and from gateway 20, and captures and stores all messages for debugging and auditing purposes, including text messages which are delivered, undelivered, responses errors, etc. Preferably, central control center 10 only accepts messages from gateway 20 over a secure intranet using, for example, a Secured Sockets Layer (SSL) protocol, or over a Virtual Private Network (VPN) and should reject messages from invalid sources. Central control center 10 and gateway 20 should preempt any other message for all emergency messages. Central control center 10 provides an interface to monitor health of the gateway 20 both next to real-time and historical reporting. Monitoring data to be provided includes gateway queue sizes (in/out), central control center queue sizes (in/out), gateway connections, messages per second and total error messages.

In one embodiment, the system 400 includes a locationing system whereby the geographical location of each respective vehicle 199 can be determined. The locationing system relies on location information which may be provided by the wireless service provider 30, or by a separate Global Positioning System (GPS), or by a combination of both. Location information provides details regarding the geographical location of an individual or item. Preferably, location information detailing the geographical location of each vehicle 199 is provided to the central control center 10 on the remote server 240 in real-time or near real-time. In one embodiment, the locationing system includes a location-based sensor 222, such as a GPS sensor which includes circuitry to detect and triangulate GPS signals in order to determine the location of the vehicle 199. Preferably, the location-based sensor 222 is in or on the vehicle 199, and preferably, the in-vehicle equipment 203 includes the location-based sensor 222 which is in communication with the other components of the in-vehicle equipment 203.

In one embodiment, central control center 10 captures all shift data (such as logon, logoff, power on, power off, etc.) from the vehicles 199, and preferably all messages relating to shift and fares. Preferably, central control center 10 also capture trip 235 records, vehicle identification and owner identification data, trip 235 identification and authorization limit (on-line, floor limit), vehicle status (live or out-of-service), captured batches (date, batch number, total fares, total transactions), and fare data (date, trip number, batch number, itemized fare).

In particular, the wireless service provider 30 may receive certain passenger information 204, such as payment information, from passengers 229, forwards the payment information to a credit card processor, and selectively returns a verification that the payment was successfully made. The wireless service provider 30 provides a plurality of other communication functions, such as text messages and internet access to passengers in a plurality of vehicles 199.

Typically, a vehicle 199 is equipped with a meter 210, a passenger information monitor (PIM) 220, a driver interactive unit (DIU) 230 and a wireless communication device 241. The PIM 220 is coupled to the central gateway 20 through wireless communication device 241, and provides information such as primary content 227 to the passenger 229, such as vehicle and driver identification information and other information related to the pairing and entering the passenger trip code 221 with the in-vehicle equipment 203 and transmitting it to the remote server 240. Primary content 227 may be targeted content based upon additional information such as passenger information 204 and vehicle information 205, and may include thing such as fleet logos, driver identification, and a map or route information. Primary content 227 is may be downloaded in advance and stored on, the in-vehicle equipment 203, such as PIM 220.

Preferably, PIM 220 is a mobile computer 100 comprising a display 225, such as an integrated touch screen display, recessed into a partition and directly viewable by a passenger 229 positioned in a passenger seat of the vehicle 199. Preferably, PIM 220 includes a card reader for receiving financial information from a credit card or debit card. Preferably, PIM 220 also includes other peripherals used for presenting primary content 227, such as speakers 223, and certain peripherals for interacting with the primary content 227, such as a capacitive touchscreen display, buttons, and/or a keyboard.

Preferably, during a trip 235 in the vehicle 199, PIM 220 allows passengers 229 to track their journey on one of several maps with different views and to monitor tolls and surcharges. The passenger may also watch primary content 127, such as multimedia content, on the display 225, and in some embodiments, optionally use the PIM 220 to access the Internet via wireless communication device 241 using a wireless network 226, as shown in FIG. 2. At the end of the trip 235, PIM 220 may enable the passenger 229 to pay for a fare using one of a number of payment means, such as a credit card, a debit card, or an NFC device. Optionally, the PIM 220 may provide for the easy calculation of tips by interaction with the display 225. In one embodiment, at the end of the trip 235, the passenger 229 pays for the fare or a portion of the fare by entering the passenger trip code information corresponding to the passenger trip code 221.

Preferably, the PIM 220 in each respective vehicle 199 itself initiates polling communications with central control center 10 in order to provide or obtain information 204, 205, 227, 228 to and/or from the central control center 10. In these polling communications, the PIM 220 may announce itself and inform the central control center 10 of its software version, advertising version and other important operating parameters of the PIM 220. PIM 220 can then be updated as desired. Preferably, these polling communications do not occur at points in times that are in common with other vehicles 199 in the fleet. For example, polling communications can be made to occur periodically and/or whenever PIM 220 is powered on or otherwise comes on-line.

Since the PIMs 220 of each vehicle 199 in the fleet will generally be powered on or come online at different times, the polling communications and the updates will occur at different times for different vehicles 199. For periodic polling communications, different vehicles 199 can perform its polling communication at different times. For example, if a polling communication is to be made once per hour, some vehicles 199 can perform polling communications at one minute past the hour (i.e., at 8:01, 9:01, etc.) while other vehicles 199 perform its polling communications at six minutes past the hour (i.e., at 8:06, 9:06, etc). Preferably, PIM 220 is configurable or programmable to operate as described herein to support multiple polling communications with different parameters.

All polling communications need not be the same and updates in response to polling communication need not be handled in the same manner. In particular, the polling communications and updates related to fleet management may be handled differently than other kinds of communications, such as those related to obtaining primary content 227. While news or other kinds of multimedia content may be time sensitive and need to be updated immediately, all updates need not occur immediately after the polling communication. For software updates and other updates that will not be utilized until the PIM 220 is powered off and then on again, the update may be downloaded over a period of time. For polling communications related to time sensitive updates, such as news, the update need not be delivered directly from the central control center, but the central control center 10 may, in response to the polling communication, indicate from where PIM 220 may obtain the update. When the update is complete, PIM 220 reports back the completion to central control center 10.

Central control center 10 keeps an inventory of each PIM 220 in the vehicle fleet and its respective update and download status. An example of a PIM configuration available may include a snapshot of the current status of all updates; software, daily content updates, full look replacements, ticker, and miscellaneous updates. A vehicle 199 may be out-of-service for three days and not make any polling communications during that time. The central control center 10 will track this, and provide missed updates, and may also skip updates that are no longer appropriate to provide because they are untimely, or are superseded by other updates, etc., to manage the PIM 220. However, unlike the previous broadcast distribution, it is incumbent upon each one of the PIMs 220 to check in with the central control center 10 and update itself.

DIU 230 allows a driver 233 of the vehicle 199 to log on and off the system 400 by using a secure passcode, such as a password or personal identification number (PIN). DUI 230 is the driver 233's primary tool for interacting with the PIM 220 and particularly, for assisting passengers 229 with financial transactions, such as credit card and debit card payments. DUI 230 is preferably a small multi-functional box including a computer that is installed to the right side of the vehicle 199's steering wheel in close reach and easily viewable from the driver 233's seat. DUI 230 features an easy to use interface, and preferably includes input device 244, such as a touchscreen or buttons which correspond to various responses that appear on the display 225 of PIM 220—depending upon the action that is currently taking place in the vehicle 199. For example, the driver 233 may facilitate payment transactions by selecting a button or buttons that correspond to simple responses like “yes” and “no” in response to questions like “are all amounts entered correct?” Through its interface, DUI 230 allows the driver 233 to interact with the PIM 220, and in turn, the passenger 229 via the PIM 220.

DIU 230 is optionally coupled to other devices for displaying messages and may display messages from the fleet manager and, optionally, governmental agencies. Some text messages require no responses and others will prompt the driver 233 to respond using pre-set responses on DIU 230. Predefined text messages can also be sent from the driver 233 to the fleet.

The system 400 is broken into several application components. A customer facing component which runs on the PIM 220. Gateway and central control center application components work in tandem to service all messages to and from PIM 220. These messages include trip sheet data, credit card processing messages and AVL messages for spatial queries. Additionally, the central control center 10 utilizes payment processing switches to facilitate secure, reliable processing of financial information. Finally, Web Portal and Shared Services application components are used to display and report on all captured data within the system 400. More information on components of system 400 may be found in U.S. patent application Ser. No. 12/171,372, filed on Jul. 11, 2008 and entitled “VEHICLE FLEET MANAGEMENT,” is incorporated herein by reference.

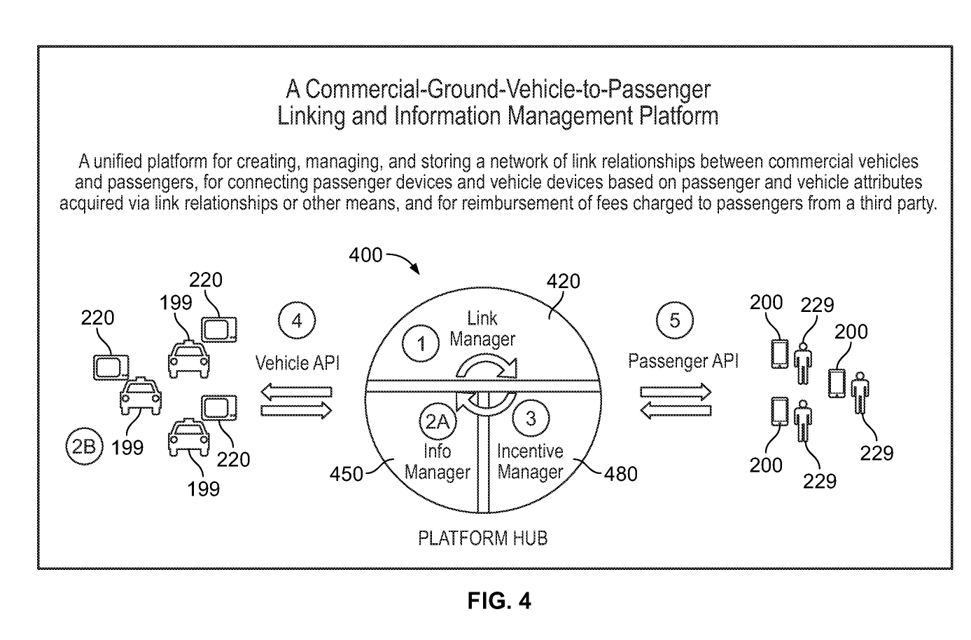

With reference to FIG. 4, in one embodiment, the commercial ground vehicle-to-passenger linking and content management system 400 includes a link manager 420 which retrieves passenger information 204 from passenger 229 via mobile device 200 and links the passenger information 204 from passenger 229 with vehicle information 205 from the vehicle 199, an information manager 450 which sends and receives information and content 227 to the passenger 229 (via a number ways, such as through the PIM 220 and/or the mobile device 200) based on passenger information 204 and/or vehicle information 205, and an incentives manager which provides incentives to the passenger 229 to receive additional passenger information 204 from the passenger 229.

Preferably, the in-vehicle equipment communicates with the remote server 240 to retrieve content 227 and 228 from the remote server 240 to be presented to the passenger. The content 227 and 228 may be presented exclusively on the passenger 229's mobile device 200, or the primary content 227 may be presented on in-vehicle equipment 203, such as PIM 220, and the additional content 228 may be presented on the passenger 229's mobile device 200.

Preferably, the wireless communication device 241 is used to communicate information between the remote server 240 outside of the vehicle 199 and the in-vehicle equipment 203.

Preferably, the in-vehicle equipment 203 is provided with passenger information 204 and vehicle information 205. In one embodiment, the passenger information 204 is provided to the in-vehicle equipment 203 by the passenger 229, preferably via the passenger's mobile device 200. In one embodiment, the passenger information 204 is automatically generated, preferably by in-vehicle equipment 203 based on information picked up by in-vehicle equipment 203, such as location information, images taken of the passenger or the surroundings, and other such information. The automatically generated passenger information 204 is then provided to the in-vehicle equipment 203. Preferably, the in-vehicle equipment 203 is also provided with vehicle information 205, either via the driver 233 or automatically generated using in-vehicle equipment 203.

In one embodiment, the passenger 229's mobile device 200 communicates with and provides information to the in-vehicle equipment 203 either directly via a pairing procedure in which the mobile device 200 pairs with the in-vehicle equipment 203, or indirectly via remote server 240.

In one embodiment, the passenger information monitor 220 is provided with and sends passenger information 204 along with vehicle information 205 to the remote server 240 via the wireless communication device 241, and the passenger information monitor 220 receives primary content 227 to display on the display 225 in response to the provided passenger information 204. Preferably, the mobile device 200 receives additional content 228 to display on a display 206 of the mobile device 200. Preferably, the additional content 228 is displayed in conjunction with the primary content 227. Preferably, the additional content 228 and/or the primary content 227 is received in response to the provided passenger information 204 and/or vehicle information 205. Preferably, the additional content 228 is related to the primary content 227. Preferably, the additional content 228 is displayed simultaneously with the primary content 227. In this manner, there can be some relationship and some interaction between the primary content 227 and the additional content 228, adding to the passenger 229's experience in the vehicle 199. In one embodiment, the additional content 228 includes a request to the passenger 229 to enter the passenger trip code information.

The vehicle information 205 is any information regarding the vehicle 199, such as the vehicle 199's unique ID, VIN number, serial number, license plate, registration number, make, model, color, and location. Preferably, the vehicle information 205 includes one of environmental information, location information, route information, time information, and date information.

The passenger information 204 is any information regarding the passenger 229 or the trip 235, such as passenger trip code information related to the passenger trip code 221, the passenger 229's name, address, telephone number, financial information, physical description, sex, age, job title, profession, likes, dislikes, hobbies, interests, and such. In one embodiment, the passenger information is a unique code or identifier which uniquely identifies the passenger, such as the passenger's name, social security number, membership rewards no., membership no., etc.

In one embodiment, the passenger information 204 is linked with the vehicle information 205, preferably via the link manager 420, and used to drive content 227 and 228 to the passenger 229 via the passenger's mobile device 200 and/or in-vehicle equipment 203, preferably using the information manager 450.

In one embodiment, the passenger 229 interacts with the primary content 227 on the passenger information monitor 220 via the additional content 228 on the mobile device 200. In one embodiment, the primary content 227 is an advertisement, a game, or a survey, and the additional content 228 is a related advertisement, related content, or an application which allows the passenger 229 to interact with the advertisement, the game, or the survey.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a computer readable memory medium such as a magnetic medium like a hard disk drive, and solid state drive magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents.

1. A system comprising:
in-vehicle equipment within a fleet vehicle including an input device for receiving and inputting passenger trip code information from a passenger of the vehicle, a location-based sensor to determine the location of the fleet vehicle, and a wireless communications device connected with the input device, wherein the in-vehicle equipment comprises associated driver circuitry, processing circuitry, network interface circuitry, and control circuitry, wherein:
said location-based sensor and associated driver circuitry are operable to capture the location of the vehicle and transmit vehicle location information including the location of the vehicle periodically to the remote server;
said remote server, upon receiving a request from a third party to initiate a trip reservation for the passenger from a first location to a second location, using the vehicle location information, designates the fleet vehicle for use in the trip and associates a passenger trip code with the trip for the passenger in the fleet vehicle, and communicates the passenger trip code to the in-vehicle equipment;
communicating passenger trip code information received from the passenger to the remote server via the in-vehicle equipment, wherein said control circuitry is operable to detect signals from said input device that represent the passenger trip code information;
comparing the passenger trip code information received from the passenger via the in-vehicle equipment with the passenger trip code associated with the trip for the passenger in the fleet vehicle, in order to validate the trip reservation, wherein if the passenger trip code information matches the passenger trip code, and the passenger trip code is still valid, the trip is validated, and wherein the third party bills the passenger for at least a portion of a cost of the trip.

2. The system of claim 1, wherein said location-based sensor and associated driver circuitry are operable to capture the location of the vehicle and transmit vehicle location information including the location of the vehicle periodically to the remote server.

3. The system of claim 1, wherein remote server, upon receiving a request from a third party to initiate a trip reservation for the passenger from a first location to a second location, using the vehicle location information, designates the vehicle for use in the trip and associates a passenger trip code with the trip for the passenger in the vehicle, and communicates the passenger trip code to the in-vehicle equipment.

4. The system of claim 1, further comprising:
communicating passenger trip code information received from the passenger to the remote server via the in-vehicle equipment, wherein said control circuitry is operable to detect signals from said input device that represent the passenger trip code information; and
comparing the passenger trip code information received from the passenger via the in-vehicle equipment with the passenger trip code associated with the trip for the passenger in the vehicle, in order to validate the trip reservation, wherein if the passenger trip code information matches the passenger trip code, and the passenger trip code is still valid, the trip is validated.

5. The system of claim 1, wherein the owner of the vehicle receives reimbursement from the third party for at least a portion of the cost of the trip charged to the passenger.

6. The system of claim 5, wherein the owner of the vehicle receives reimbursement from the third party via a monthly licensing fee or a percentage of a fee paid to the third party for goods or services by the passenger.

7. The system of claim 5, wherein the third party is providing additional goods or services to the passenger, and wherein payment for the additional goods or services provided to the passenger subsidizes a portion of the cost of the trip charged to the passenger.

8. The system of claim 5, wherein the third party is a hotel from which the passenger is paying for a room.

9. The system of claim 1, further comprising a mobile electronic communications device, wherein the remote server communicates the passenger trip code to the passenger via the mobile electronic communications device.

10. The system of claim 9, wherein the passenger trip code is send via SMS Message to the mobile electronic communications device.

11. The system of claim 1, wherein passenger trip code information is manually entered into a passenger information monitor of the in-vehicle equipment.

12. The system of claim 1, wherein vehicle identifying information is provided to the passenger in advance of the passenger entering the vehicle, so that the passenger may identify the vehicle, and wherein the vehicle identifying information includes the vehicle location information.

13. The system of claim 1, wherein passenger identifying information is sent to the vehicle in advance of the passenger entering the vehicle, and wherein the passenger identifying information includes passenger location information regarding the location of the passenger.

14. The system of claim 1, wherein if the passenger trip code information matches the passenger trip code, and the passenger trip code is still valid, the trip is validated.

15. The system of claim 1, wherein upon completion of the trip, the third party bills the passenger for at least a portion of a cost of the trip.

16. A method comprising:
performing by one or both of an electronic communication device or at least one server:
prompting, at a display of the electronic communication device, a user to enter a passenger data point identifying a passenger and indicating the passenger's request to initiate a trip;
detecting signals from an input device of the electronic communication device that correspond to an input, by a user of the electronic device, of the passenger data point identifying the passenger and indicating the passenger's request to initiate a trip;
communicating the passenger's request to initiate a trip via an offer to a second electronic communication device of a driver of a vehicle;
prompting, at a display of the second electronic communication device, the driver to accept or deny the offer to initiate a trip for the passenger;
pairing the passenger data point with a vehicle data point associated with the driver upon acceptance of the offer; and
charging the fare upon completion of the trip.

17. The method of claim 16 further comprising directing the driver of the vehicle to a current location of the passenger using a global position system (GPS).

18. The method of claim 16 further comprising presenting, at a display of the electronic communication device, passenger trip information.

19. The method of claim 16, wherein the user is a third party other than the passenger or the driver.

20. The method of claim 19, wherein the third party is charged the fare upon completion of the trip, and wherein the passenger reimburses the third party for the fare.

21. The method of claim 16, wherein the passenger is directly charged the fare upon completion of the trip.

22. A method comprising:
performing by one or both of an electronic communication device or at least one server:
prompting, at a display of the electronic communication device, a user to initiate a request for a trip either by requesting the user to respond to a third party via text message or requesting a user to select a link provided by the third party to the user in a text message;
detecting signals from an input device of the electronic communication device that correspond to an input, by a user of the electronic device, identifying the passenger and indicating the passenger's request to initiate a trip;
communicating the passenger's request to initiate a trip via an offer to a second electronic communication device of a driver of a vehicle;
prompting, at a display of the second electronic communication device, the driver to accept or deny the offer to initiate a trip for the passenger;
pairing the passenger with a vehicle associated with the driver upon acceptance of the offer; and
charging the fare to the passenger or the third party upon completion of the trip.

23. The method of claim 22 further comprising directing the driver of the vehicle to a current location of the passenger using a global position system (GPS).

24. The method of claim 22 further comprising prompting the passenger to identify the passenger's current location.

25. The method of claim 22, further comprising charging the fare to a non-passenger billed entity before charging the third party or the passenger, where the non-passenger billed entity then later charges the passenger or the third party for the cost of the fare plus any additional costs.
